(19) United States
(12) Patent Application Publication
(10) Pub. No.: US 2010/0229802 A1
(43) Pub. Date: Sep. 16, 2010

(54) BARRIER MOUNTED ANIMAL CONTAINMENT APPARATUS

(76) Inventor: Paul Bok, South Australia (AU)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/530,532

(22) PCT Filed: Mar. 6, 2008
(86) PCT No.: PCT/AU08/00308

§ 371 Date: Mar. 16, 2010

(51) Int. Cl. E04H 17/00; A01K 1/00

(52) U.S. Cl. 119/416; 256/12

(57) ABSTRACT

An animal containment apparatus (10) adapted to be mounted to a fencing arrangement (32) or building structure, the apparatus (10) including an elongated prop member (14), pivotally supported (34) about a length of the fence (32) or building structure, having an outer peripheral edge separated by intermittent ingresses along the length of the prop member (14), such that when the paw (30) of an animal (28) makes contact with the prop member (14), the paw engages an ingress, causing the prop member to rotate and preventing any leverage for the animal (28) to climb or scale over the fence (32) or building.

### TECHNOLOGICAL FIELD

This invention relates to an apparatus for containing and restricting animals within and from a defined space, and/or preventing their access into or onto such defined spaces.

More particularly, this invention relates to an animal containment apparatus, the kinds one would associate for household pets, birds and wild animals such as possums and rodents, so as to keep them within or away from the boundary of a household or away from defined areas such as roof tops and the like.

### BACKGROUND ART

At present there are a variety of ways in which animals can be contained or inhibited from accessing certain defined spaces within a conventional household premise.

Those that are skilled in the art of providing such animal containment arrangements or systems are aware that simple fences such as a barrier are not enough to confine domestic pets, such as cats from either remaining in a particular household or seeking access to a neighbouring property.

The word fence is to be defined as non limiting and simply represents a term that describes the boundary of the defined space to which containment or unauthorised access is required.

The reason being is that a conventional fence due to its sturdiness of construction presents a structure to which the animal can easily gain a foothold on top of the fence and leverage their way there across into the adjacent premise.

One way of making the conventional fence slightly more conducive to confining domestic pets therein a specified space or at least inhibiting access from neighbouring properties into a particular household is through the use of electric fencing. Physical electric fencing, which uses an electric shock to discourage contact with the fence might be appropriate on large farms for control of livestock nonetheless the use of such electrical fences to keep in or prevent access to domestic pets in an urban or even suburban environment is undesirable, not the least because the high voltage electrical impulses applied to these “live” fence wires could easily be inadvertently energised not by animals but by members of the public, particularly children.

Even though these pulses last for just a few thousandths of a second it can cause quite substantial pain particularly if an animal or even a member of the purchasing public is unaware how to disengage themselves from the electric fence.

Still further not only are these electrical fences arguably quite dangerous, they are also inhumane, difficult to install and require regular maintenance of electrical contacts.

Nonetheless if conventional and electrical fencing is to be ignored in the control and containment of domestic pets in urban areas, it cannot be ignored that something else must be done, as it is inappropriate for a household to allow their own domestic pets to leave their own property and access neighbouring households, and at the same time it is equally undesirable for neighbouring households with their own domestic pets to seek their own intrusion into property to which the owners have no connection with this domesticated animal.

Accordingly in an attempt not to ignore this problem of containment of animals within populated areas but keeping away from inhumane enclosures utilising systems such as electrical fencing the prior art has come up with one very unique way of attaching a rotatable column along the length of a fence bordering respective properties.

The purpose of this rotatably supported column is that as the cylindrical column will rotate when the domestic pet tries to gain a foothold or leverage to cross the fence, this unsteadiness of foot caused by the rotation of the column will cause the animal to fall back down.

Hence these rotating poles or columns extending along the fence structure work by commencing rotation when the legs, feet or paws of the animal touch the pole wherein the subsequent rotation thereof denies any grip or the like to the domesticated animal as it attempts to climb over the fence.

Advantageously the domesticated animal by not being able to gain a foothold at the top of the fence means that their ability to scale and jump over the fence is completely hindered.

If these cylindrical poles or columns running along the top of the fence are to be effective they must be of considerable dimensions. Currently these kinds of rotating columns or poles presented to the purchasing public are of a scale that does not effectively hinder the ability of the domestic pet to scale and jump over the fence. The reason being is that the suppliers of such product still want the arrangement to blend in appropriately with the fence structure to provide the necessary aesthetics.

The problem being is that in the attempt to present a rotatable column or pole of dimensions where it can be conveniently fitted to the top of the fence both from a point of view of construction and also aesthetics, is that the consequence is loss of the overall purpose and functionality of the arrangement.

As the person skilled in the art will appreciate, if these rotating poles or column are not of considerable dimensions, the domesticated animal or pet, particularly a cat will have no difficulties in gaining a foothold on top of the arrangement and then simply jumping or even making use of the momentum of a single rotating pole to clear the fence.

A further problem with such an arrangement is that as the diameter of the single pole arrangement increases, in order to improve the functionality and the utility of the containment device, so to is the creation of a variety of problematic situations, not the least that one large rotating column could easily capture the paw or leg of the domestic animal pinning it or trapping it to the top of the fence.

Still further, if the dimensions of the rotating column or pole are at the level required to prevent the animal from scaling and jumping over the fence, it is likely then to be of a structural dimension quite considerable in design, which means its weight and size would make it difficult to simply secure or fasten to a fence and still further the actual aesthetics of the fence is substantially lost, given at the top of the fence is a particularly large pole running along its length.

Therefore an object of this invention is to provide an animal containment apparatus which will contain or inhibit access of an animal, including birds from a defined area or space, which is simple to install, aesthetic and humane to the animal to which it is containing.

### SUMMARY OF THE INVENTION

Accordingly, in one form of the invention there is provided an animal containment apparatus adapted to be mounted to a fencing arrangement or building structure, said apparatus including:

an elongated prop member, pivotally supported about a length of said fencing or building structure,

said prop member having an outer circumferential edge or length, separated by intermittent ingresses along said members circumferential edge or length,

such that when the paw of an animal makes contact with the prop member, said paw engages the intermittent ingress, causing said prop to rotate, thereby withdrawing any leverage available for said animal to climb or scale over the apparatus.

Preferably the prop member is a longitudinal criss-cross of blades, or a continuous elongated star configuration of crossing blades wherein the blades radially converge on the one central pivotally supportable axial.

An advantage of such an arrangement is that when the prop member is mounted across the length of the fencing, it would appear to the animal being contained within the defined space, that the prop member offers the opportunity for the animal to jump up, grab access to the prop member and thereafter climb over the fencing arrangement.

For example, if the prop member was simply a continuous cylindrical column or pipe, as it is in the prior art, when the animal jumps up onto such a prop member, the continuous circumferential edge of the outer periphery defined by such a structural feature, means that in many instances the animal is able to grab a certain amount of leverage, or holding, on the cylindrical rod and thereafter climb over.

Nonetheless, in this arrangement, while the converging baffles or blades arguably still present, from a visual point of view, a continuous rotatable column, as the circumferential edge or periphery has been interrupted by intermittent shoulders or ledges by the fact of having convergent blades or platforms criss-crossing each other, when the animal makes an attempt to scale the fence and comes in contact with the prop member, rather than grabbing a foothold along the circumferential edge of the cylindrical rod or the like, the paw in fact will rest upon the ledge or the platform of the blades, which in turn, instead of working in favour of the animal, causes the prop member to rotate, thereby withdrawing any leverage available to the animal attempting to climb over or scale the fence.

While a continuous cylindrical column or drum is a structural feature easy to install along a length of fencing, the problem clearly remains in that such arrangements are not always effective, and as discussed above, in many instances the animal is still able to gain a foothold or leverage along the circumferential edge of the cylindrical rod or column and ultimately scale the fencing arrangement.

Advantageously in this invention, by introducing these intermittent regions along the circumferential edge, which in this embodiment was provided for by having a series of blades or platforms converging on the one radial axis, means that the animal is presented with a prop member with inherent features that in fact will work against the animal trying to scale a fence once contact is made.

As the person skilled in the art will appreciate, there are literally scores and scores of different structural arrangements possible in having blades or platforms converge radially on the one axial support.

For example, in some embodiments the blades or platforms could be elongated narrow sheets, which simply transverse each other at the one central axis to be pivotally supported by the same arrangement.

In a further preferred embodiment of the invention the prop member is an elongated spindle wherein the circumferential edge of the member is divided along its length into intermittent creases or sleeves.

Advantageously, with this arrangement the intermittent regions are introduced not longitudinally across the prop member, but in fact laterally, as one works their way longitudinally along the length or the prop member.

As is to be expected, the animal still sees the prop member as that point of leverage required to ultimately scale the fence, but once making contact with the containment apparatus, the paw will slide into that intermittent region, which in this spindle arrangement will be the sleeve or spacing in between adjacent winds, thereby causing the prop member to rotate, which in effect will withdraw any hold available for the animal as it attempts to climb or scale the fence.

Again, advantageously it is now possible to install an apparatus of similar dimensions to one long cylindrical column, but then unlike the cylindrical column, access for the animal to gain any hold or leverage upon the prop member is not provided for. As introduced above, once the animal jumps up and grabs the prop member, the paw will slip into the sleeve or crevice, and the animal then loses all its leverage in order to complete the climbing over the apparatus.

In a further form of the invention there is provided an animal containment apparatus adapted to be fastened to a fence or building structure, said apparatus including:

a frame member adapted to pivotally support a barrier member;

said barrier member including at least three symmetrically arranged rods, each rod rotatably independent of an adjacent rod;

such that when the apparatus is positioned along said fence or building structure and said animal makes contact thereto said apparatus, the said animal is prevented from gaining a foothold to leverage over said fence or structure due to the rotation of the barrier in conjunction with rotation of at least one of said rods.

Again this embodiment of the invention remains faithful to the overriding essential feature that being the prop member, which in this case includes at least three symmetrically arranged rods, each rod rotatably independent of an adjacent rod, having an ingresses about the circumference of the prop member. Hence instead of the prop member being a complete circular rod, the 3 apexes of the triangle provide something similar to a column but with the circumference edge interrupted. It is these ingress interruptions about the circumference edge that provides for the means to which the prop member begins to rotate thereby causing the animal to lose any foothold.

In order to gain an appreciation of the invention, further description is now provided herewith with several preferred embodiments, with the assistance of the accompanying illustrations.

### BRIEF DESCRIPTION OF THE ILLUSTRATIONS

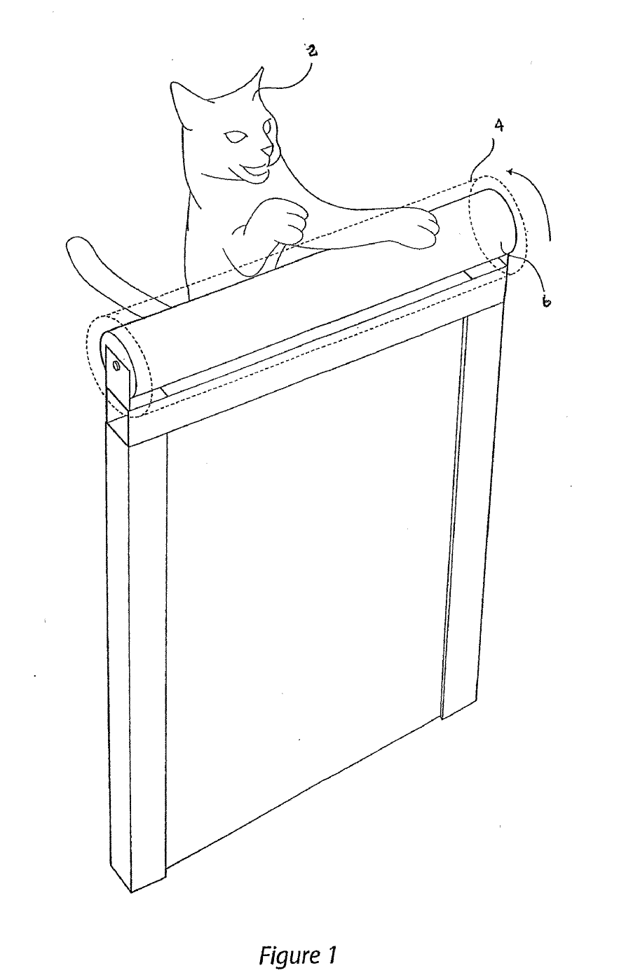

FIG. 1 is a representation of the prior art using the conventional column or pole which rotates when touched by the domestic animal as it attempts to climb the fence and gain a foothold thereon in order to scale and jump over said fence.

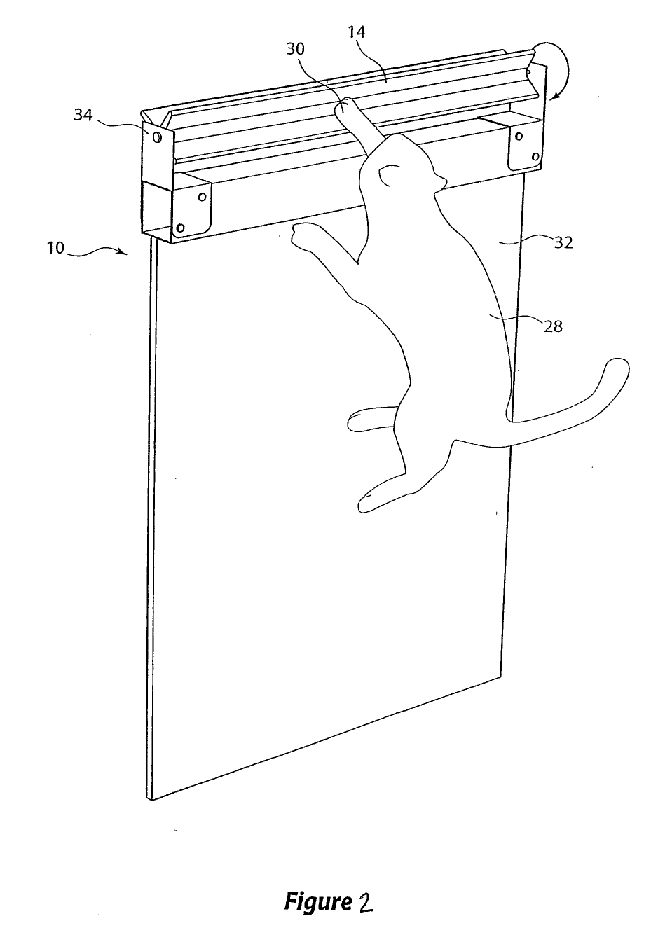

FIG. 2 is a perspective view of one embodiment of the invention wherein the prop member is characterised with the longitudinal criss-cross of blades, baffles or platform.

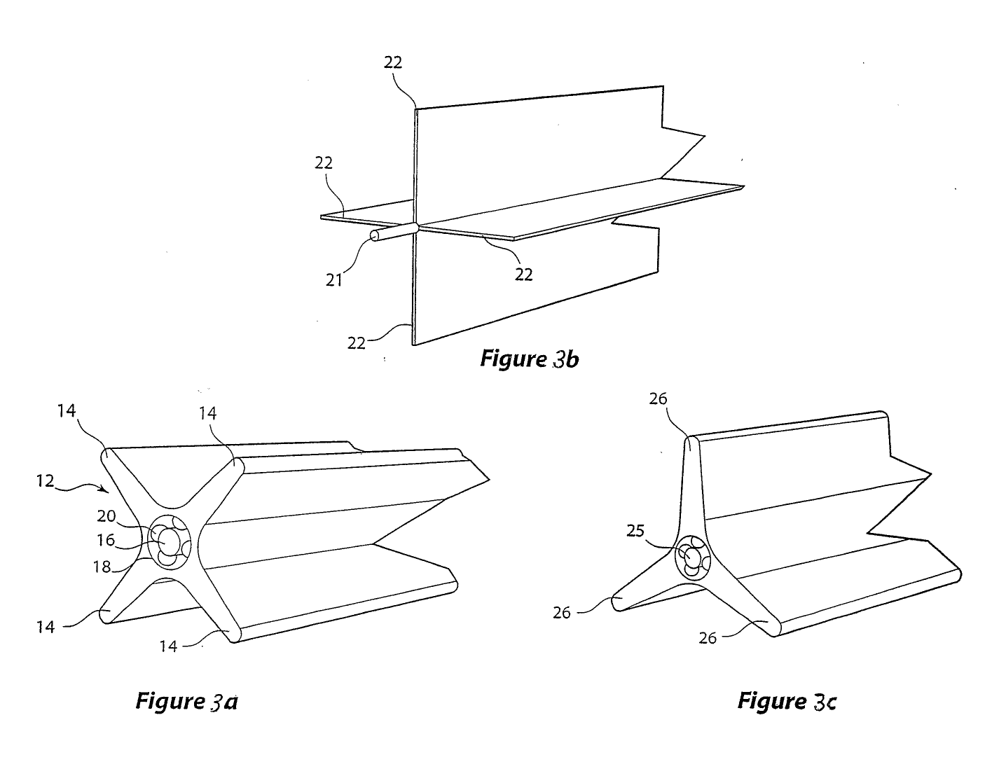

FIGS. 3a, 3b AND 3c show various representations as to how the prop member utilising longitudinal blades or platforms can be constructed.

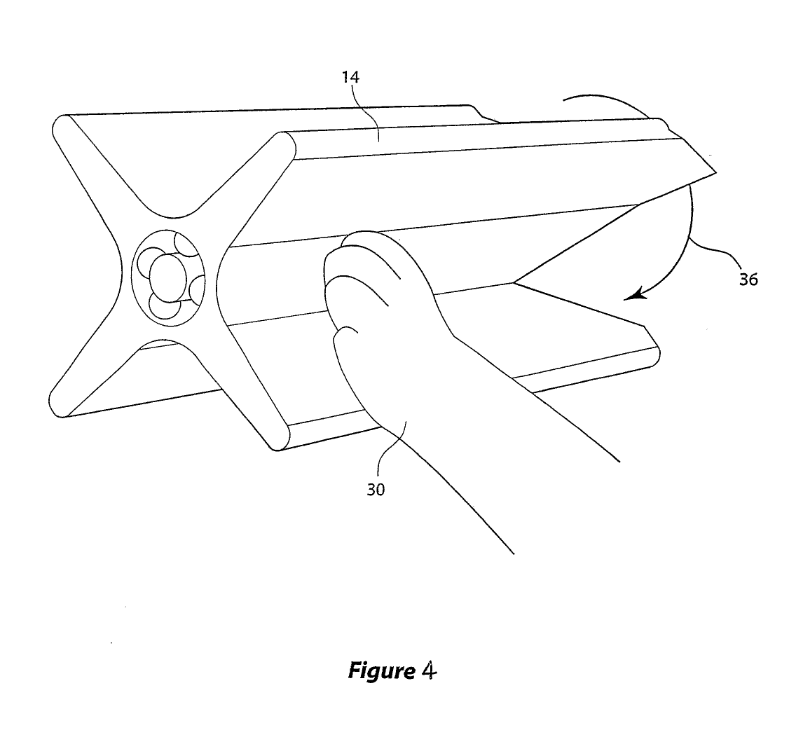

FIG. 4 shows a part exploded view of FIG. 2, wherein greater detail is provided in illustrating where the animal's paw makes contact with the prop member and coincidentally is unable to grab or take a holding on the arrangement when trying to scale the fence.

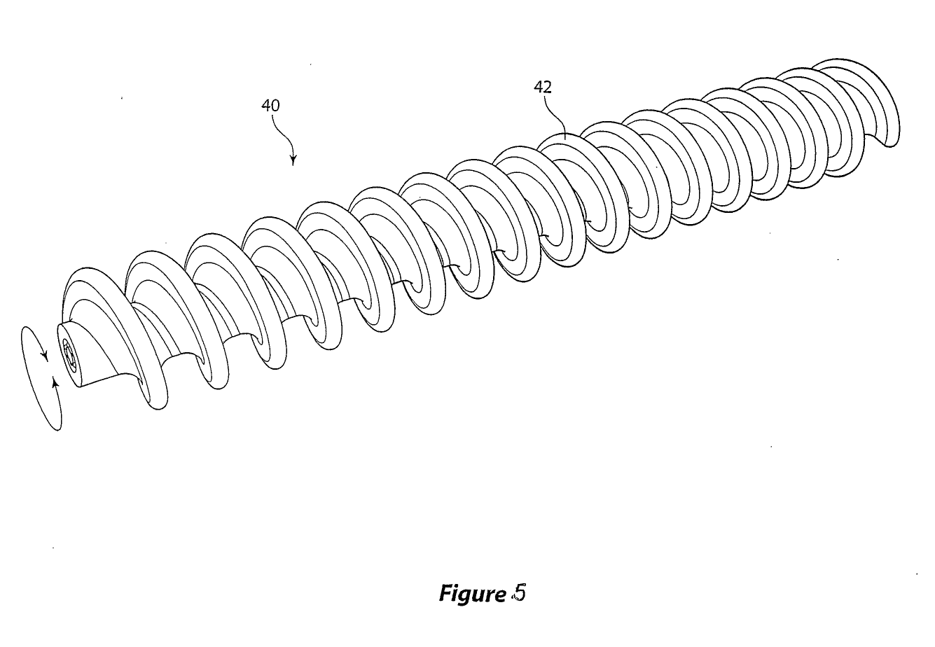

FIG. 5 shows a further embodiment of the invention wherein the prop member presents a longitudinal spindle or corkscrew type arrangement.

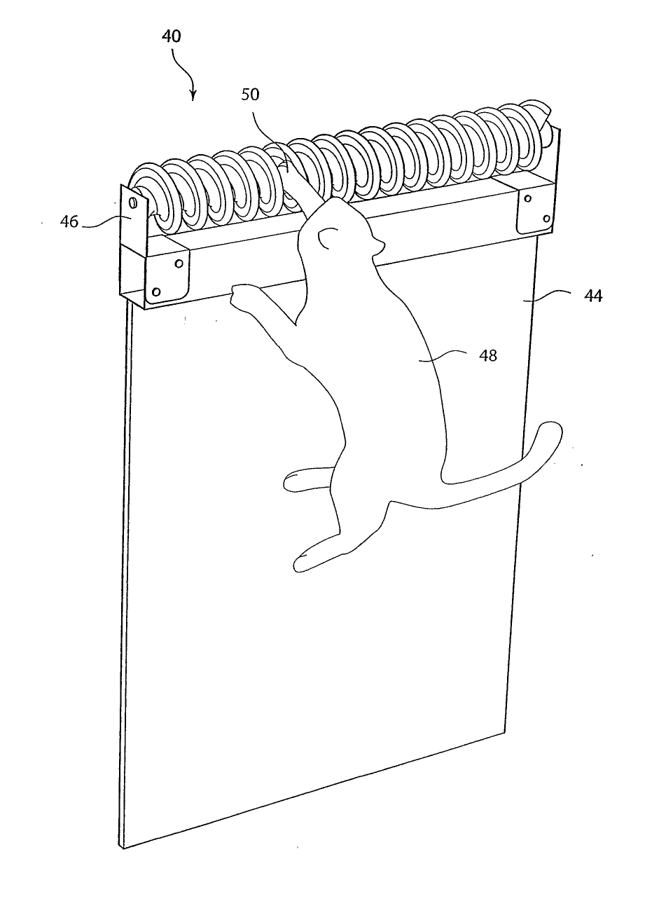

FIG. 6 is similar to FIG. 2, however, in this instance the embodiment of the spindle or corkscrew arrangement of the prop member is presented.

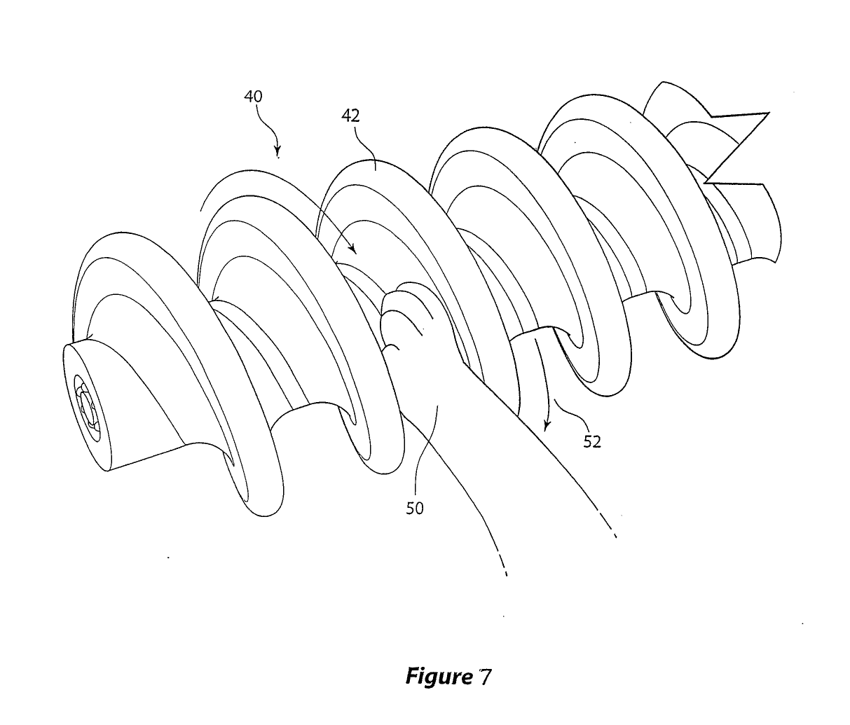

FIG. 7 is an exploded part view of FIG. 6, showing the effects of the animal's paw as it attempts to grab and take hold of the prop member with the corkscrew type arrangement.

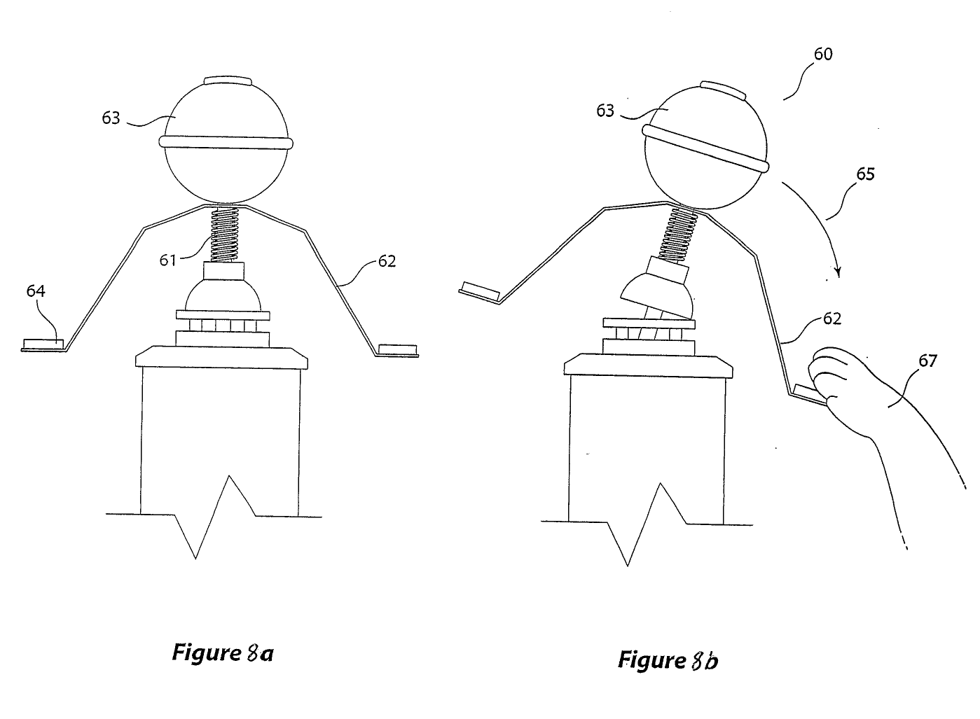

FIGS. 8a and FIG. 8b show an embodiment of a corner piece that can be used in conjunction with the prop member in certain containment areas.

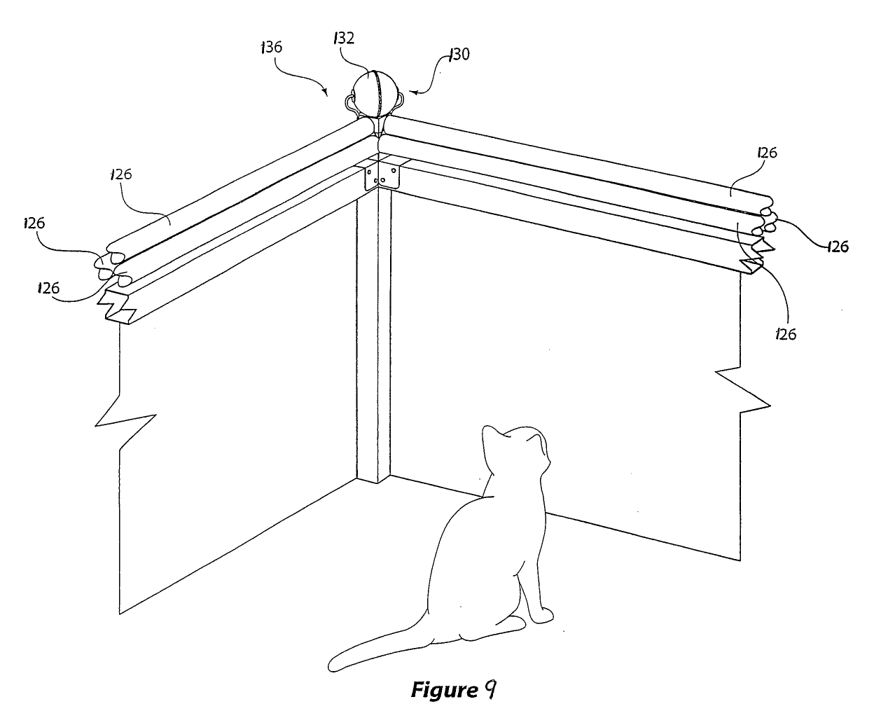

FIG. 9 is a perspective view of a further embodiment of the invention that also includes the further feature of the corner sphere member.

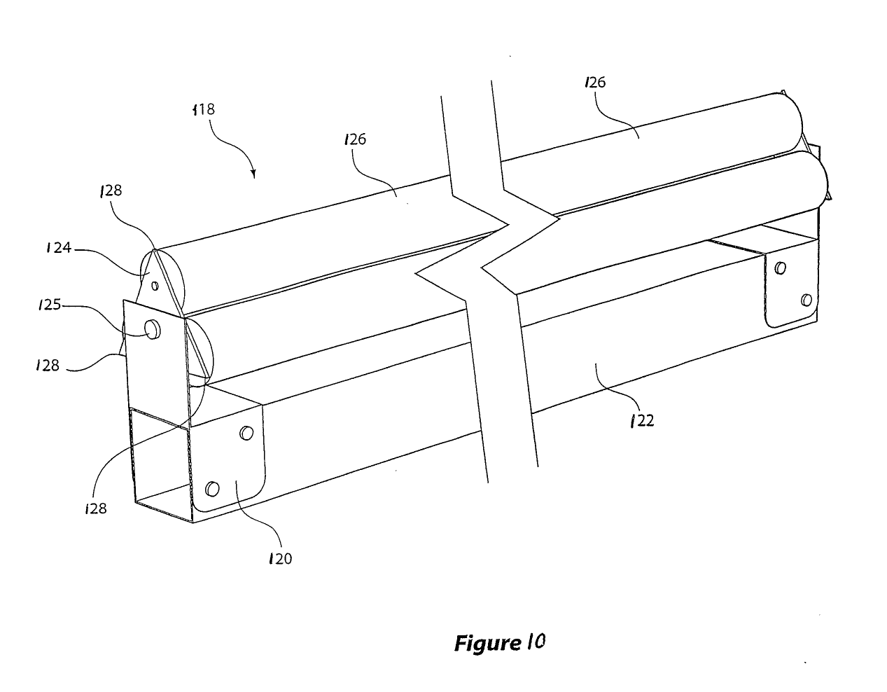

FIG. 10 shows a perspective view of the actual containment apparatus that would run along the length of the fence according to the embodiment shown in FIG. 9.

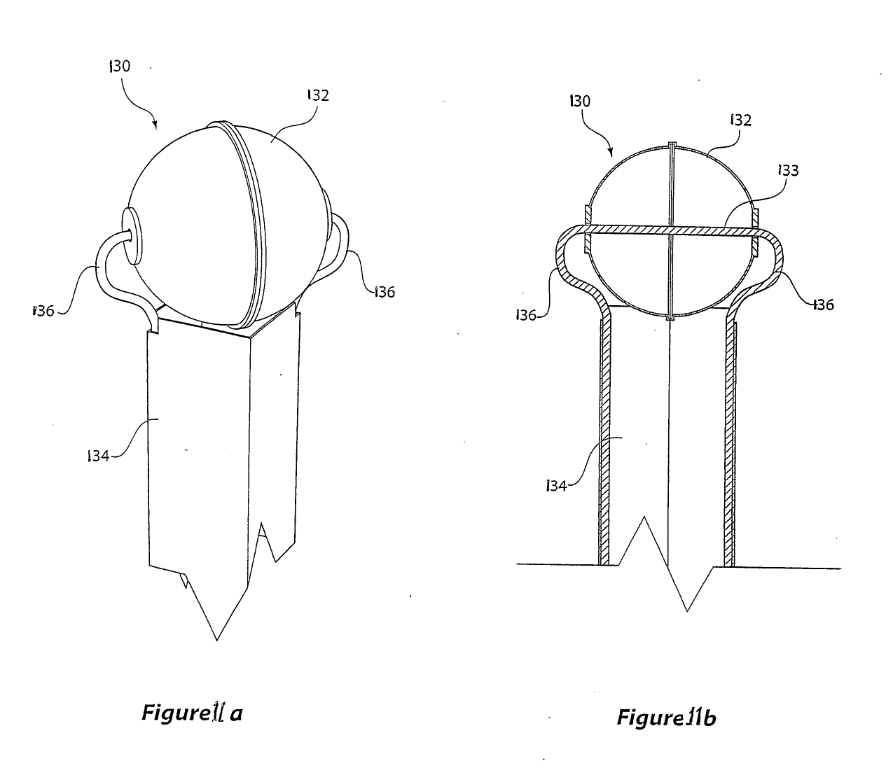

FIGS. 11a and 11b show the further feature of the animal containment apparatus associated with the corner feature when the apparatus is used in areas that in fact have corners to be protected.

### DETAILED DESCRIPTION OF THE ILLUSTRATIONS

Referring to the illustrations now in greater detail and first of all FIG. 1.

An animal, such as a domestic pet including a cat 2, attempts to climb over a fence with the rotating pole 6 preventing or at least hindering the animal's ability to scale and jump over the illustrated fence. Nonetheless the broken lines, shown at 4 of the illustrations effectively represent the appropriate dimensions that would be required for a single pole if it is to effectively provide the functionality of inhibiting or containing the animal to one side of the fence.

As introduced above several times, if the functionality of the rotating pole is going to achieve its purpose of preventing the animal from scaling and jumping over the fence, it will be so large that its dimensions make it unsightly, difficult to construct, dangerous to the animal and it will become particularly obtrusive.

The problem is exaggerated at corners wherein when these two large columns 4 converge together there will be a large space required so as the respective columns 4 do not abut or collide and inhibit the relative rotation. It would be at these corner locations, even if a single large rotation pole was effective, that an animal could easily gain a foothold at the provided space in the corner in order to scale and jump over that particular fence structure.

The prior art problem is solved as shown in 2 to 11 wherein an animal containment apparatus 10, which in this preferred embodiment is for a cat, includes an elongated prop member 14, characterised in this embodiment as a longitudinal criss-cross of blades, baffles or platforms, represented as 14, which radially converge along the one supporting pivotal axis 34.

As shown in greater detail in FIG. 3a, the baffles 14 can radially converge about the one central point 16, and with the use of a ball bearing arrangement 18, 16, can then be appropriately rotatable about the axis 34 when mounted to a bracket attached to the fence 32.

FIGS. 3b and 3c show further arrangements of these kinds of converging blades or platform members, wherein for FIG. 3b, the respective platforms 22 diagonally criss-cross about the pivotal support 21 and in FIG. 3c there are in fact three baffles 26, which converge about the central axis 25.

Nonetheless, as the person skilled in the art will appreciate, the actual final construction can be presented in literally scores of different representations, so what remains critical to the invention is the fact that intermittent regions are made available between adjacent blades or platforms, such that when the cat attempts to scale the fence 32, the paw 30 of the cat 28 has no choice but to slide onto the platform thereby sending the prop member 14 into rotation, which works totally against the animal's attempts to climb the fence, in that this rotation will withdraw any leverage available to the animal as it attempts to climb or scale the fence 32.

FIGS. 5 to 7 present the same kind of effect as available in the first embodiment, however in this instance the intermittent region is provided by sleeves, grooves or slits in between protrusions, outcrops or the like in a spindle or corkscrew type arrangement.

As can be seen in this general embodiment shown as 40, the winds 42 means that there will be gaps in between these respective outcrops, such that when the cat 48 tries to climb or scale the fence 44, the cat's paw 50 as it tries to grab and take hold as it jumps onto the arrangement, will slide into the groove and therefore lose any hold or leverage that they may have, and in fact even instigated rotation of the prop member 40, thereby working against any leverage possible in ultimately scaling the fence.

FIGS. 8a and 8b show a complimentary feature of this arrangement wherein those defined areas that require the animal to be contained within an area that includes a corner location, would further include this corner feature.

Nonetheless, it is important to know that this corner feature is only complimentary to the invention. It is simply an additional feature that brings about an advantageous overall presentation of the invention. For this broad description, the arrangement depicted in FIGS. 8a and 8b are best described as a spring loaded joy stick 60 with the ability to deflect at angles to the perpendicular and in any direction around 360 degrees at the horizontal plane.

The spring, or other resilient mechanism, holding the stem 61 of the joy stick 60 in a perpendicular position would be capable of supporting the added weight of the attachment of either one, two, three, four or more outrigger arms 62 with associated pedals or pads 64 attached thereto.

The out-trigger arms 62 and pedals 64 may be attached in any position, both in height and circumference, on the stem 61 of the joystick 60 or the attached sphere 63 of any dimension on top of the joy stick 60.

Each pedal or pad 64 would generally sit in the horizontal position at rest. When the animal jumps up and grabs the pedal 64, the animal's climbing action and its own weight will cause the pedal or pad 64 to deflect downwards in the direction of the applied force, resulting in the ball moving the same distance, thereby blocking the animal's escape in those corner locations, as shown by the arrow 65 and the animal paw 67 in FIG. 8b.

FIGS. 9, 10 and 11a, 11b introduce a further preferred form of this invention wherein a frame member 118 can be secured to a fence 122 by bracket 120.

The axle 125 provides the pivotal support of triangular bracket 124.

The pivotally rotatably supported triangular bracket 124 then rotatably supports at its three apexes shown at 128, symmetrically arranged cylindrical rods 126 that extend along a section of the fence 122.

As the person skilled in the art would appreciate the actual length of these cylindrical rods and where they would be interconnected between the triangular brackets 128 of the frame member 118 is relative to the length of the fenced area being enclosed.

Still further, the precise width between individual rods 126, their thickness and the like will also be adjustable depending on the size and type of animal to which is being contained within the arrangement.

The pivotal support provided by axel 125 within the fixed arrangement of the frame member to the triangular plate member 128 means that the triangular plate is able to rotate, but at the same time the individual cylindrical rods 126 are also able to rotate simultaneously and independently by being rotatably supported at the apexes 128 of the triangular bracket 124.

As introduced above several times it is this dual rotatability between the actual rotation of the barrier member, which in this preferred embodiment would be made up of the triangular bracket 128 and the cylindrical rods 126, and the actual independent rotation of the cylindrical rods 126 themselves independent of an adjacent cylindrical rod 126.

In certain defined areas that require an animal to be contained or at least inhibiting access into a particular area, wherein the fence structure includes corners. Again as introduced above when these kinds of spaces are presented as shown generally as 136, this sphere member, shown generally as 130.

The sphere member 130 includes the rotating sphere 132 which is rotatably supported by a frame 134 that has two arms 136 extending there from that engages a central axis 133 of the sphere 132. The frame 134 can occupy the space created by the two joining sides, so there is no foothold for the animal to access. Still further, as the sphere is the only accessible location, if the animal makes contact to scale the enclosure, the only point of contact will be the sphere 132 which will simply rotate if engaged.

1. An animal containment apparatus adapted to be mounted to a fencing arrangement or building structure, said apparatus including:
an elongated prop member, pivotally supported about a length of said fencing or building structure, said prop member having an outer circumferential edge or length, separated by intermittent ingresses along said member length or circumferential edge, such that when the paw of an animal makes contact with the prop member, said paw engages the intermittent ingresses, causing said prop to rotate, thereby withdrawing any leverage available for said animal to climb or scale over the apparatus, wherein the prop member is characterized as a continuous elongated star configuration of crossing blades wherein the blades converge on the one central pivotally supportable axis.

2. The animal containment apparatus of claim 1 wherein the apparatus further includes a frame support member adapted to fasten the pivot support for the prop member along a length of fence, building structure or section of roofing.

3. The animal containment apparatus of claim 2 wherein the frame support member is of comparable dimensions so as to be frictionally clipped along the top length of the fence or building structure to be then fixed in place by a rivet, tack, screw or nail.

4. An animal containment apparatus adapted to be mounted to a fencing arrangement of building structure, the apparatus including:
an elongated prop member pivotally supported about a length of said fencing or building structure,
said prop member having an outer circumferential edge or length, separated by intermittent ingresses along said member length or circumferential edge, such that, when the paw of an animal makes contact with the prop member, said paw engages the intermittent ingresses, causing said prop to rotate, thereby withdrawing any leverage available for said animal to climb or scale over the apparatus, wherein the prop member is an elongated spindle dividing along its length into intermittent creases or sleeves.

5. The animal containment apparatus of claim 4 wherein the elongated spindle is of the form of a corkscrew having each wind of the screw of comparable diameter with the gaps between individual winds providing the interruptions of ingresses along the length of the prop member.

6. An animal containment apparatus adapted to be mounted to a fencing arrangement of building structure, the apparatus including:
an elongated prop member pivotally supported about a length of said fencing or building structure, said prop member having an outer circumferential edge or length, separated by intermittent ingresses along said member length or circumferential edge, such that, when the paw of an animal makes contact with the prop member, said paw engages the intermittent ingresses, causing said prop to rotate, thereby withdrawing any leverage available for said animal to climb or scale over the apparatus, wherein the prop member includes at least three symmetrically arranged rods all pivotally supported about a single axis, each rod rotatably independent of adjacent rod such that, when the apparatus is positioned along said fence or building structure and said animal makes contact with said apparatus, the animal is prevented from gaining a foot hold to leverage over said fence or structure due to the rotation of the pivot support axis in conjunction with rotation of at least one of said rods.

7. The animal containment apparatus of claim 6 wherein the rods are lightweight, hollow symmetrical tubes.

8. The animal containment apparatus of claim 7 wherein the three symmetrically arranged rods are pivotally supported on the apexes of a triangular bracket, said triangular bracket also being pivotally supported and rotated within the frame member.

9. The animal containment apparatus of claim 8 further including a rotatably supportable sphere member or cone positioned at the corner of two converging sides to which prop members have been supported thereon.

10. The animal containment apparatus of claim 9 wherein the sphere is rotatably supported in a frame, wherein two arms extend from the frame to engage a central axis of the sphere.

11. (canceled)

12. (canceled)
